(19) United States
(12) Patent Application Publication
(10) Pub. No.: US 2009/0138386 A1
(43) Pub. Date: May 28, 2009

(54) INTERACTIVE STATEMENT

(75) Inventors: Carl Lee Wilson, JR., Mooresville, NC (US); Sara Osterling Rountree, Charlotte, NC (US); Robert Andrew Jones, Concord, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/944,947

(22) Filed: Nov. 26, 2007

(51) Int. Cl. G06Q 30/00; G06Q 40/00

(52) U.S. Cl. 705/30; 705/14; 705/35

(57) ABSTRACT

Systems and methodologies for generating and utilizing an interactive financial statement are provided herein. An interactive statement can initially be generated for a user based on properties relating to a device on which the user will access the statement, such as display size, available memory, and other factors relating to the device. The interactive statement can contain personal and account information relating to the user as well as interactive elements such as targeted advertising based on identified trends of a user or other factors, query functionality, security controls for individual statement features, dynamic information formatting, and other such elements. Upon generation of the interactive statement, the interactive statement can be delivered to the user.

### TECHNICAL FIELD

The subject disclosure relates generally to online document presentation, and more particularly to techniques for presenting and utilizing interactive statements.

### BACKGROUND

A financial institution, in accordance with applicable laws and regulations and general industry practice, provides a significant amount of documents to persons and/or other legal entities that hold accounts through the financial institution. These documents can include account statements, notifications, investment reports, and the like. Recently, many financial institutions have begun to offer paperless, online delivery of account statements and other documents to accountholders. By providing online delivery of documents, financial institutions are able to reduce costs associated with generation and management of large volumes of paper documents.

Most conventional online account statements are generated and delivered as static documents that are substantially identical in form and function to their paper counterparts. While such online statement delivery techniques do yield some reduction in costs and other benefits, these conventional online statements have generally not been highly adopted by accountholders. For example, static online statements are often viewed by accountholders as providing no added benefit than paper statements, leading many to continue to opt for the mailed version. In addition, accountholders that wish to view online statements on a mobile phone or similar small form-factor device may be unable to access and view static online statements, leaving paper statements as their only option. Further, accountholders that opt for static online paper statements often have difficulty in navigating and using them, which can lead to an increase in customer support work volume and associated expenses.

Accordingly, there exists a need in the art for more attractive and sophisticated techniques for online delivery of account statements and other documents.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject disclosure provides systems and methodologies for generating and delivering rich, interactive online documents, such as financial statements and other documents, for use by an accountholder. The described systems and methodologies allow for online statements that are a more attractive option to accountholders than traditional online statements. As a result, online statements may be more widely adopted by accountholders, leading to economic, environmental, and other benefits. Further, the described systems and methodologies can produce online statements that are easier to navigate and use than traditional online statements, which can result in an increase in accountholder satisfaction and a reduction in required customer support actions.

In accordance with one aspect, an interactive statement as described herein can be generated for a user based on a device on which the user will access the statement. For example, display size, available memory, and other factors relating to the user device can be considered along with user preferences. Upon generation of the interactive statement, the interactive statement can be provided to a secure location. A notification can then be provided to the user to allow the user to obtain the statement from the secure location.

In accordance with another aspect, an interactive statement as described herein can contain advertising and/or other marketing elements that can be targeted to an individual user for which the interactive statement is generated, thereby facilitating the use of online statements as an effective source of revenue. Information relating to a user, such as account information and the transaction history of the user, can be used to populate an interactive statement generated for the user with marketing elements targeted to the user. Further, marketing elements can be selected for incorporation into an interactive statement for a user based on trends identified in the transaction history of a user and/or other suitable information.

In accordance with yet another aspect, an interactive statement as described herein can utilize streamlined display features to facilitate intuitive and efficient navigation through the statement. For example, mechanisms can be provided within an interactive statement to allow an accountholder to query and/or dispute transactions reflected in the statement. Moreover, the interactive statement can incorporate various security features to control access to the statement as a whole and/or to individual portions or operations within the statement.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system for generating and accessing an interactive account statement in accordance with various aspects.

FIG. 2 is a block diagram of a system for formatting and generating an interactive document.

FIG. 3 is a block diagram of an example interactive statement in accordance with various aspects.

FIG. 4 is a block diagram of a system that facilitates inserting targeted marketing features in an interactive statement.

FIG. 5 illustrates advertisement population features of an example interactive statement in accordance with various aspects.

FIG. 6 illustrates display features of an example interactive statement in accordance with various aspects.

FIG. 7 illustrates query and authentication features of an example interactive statement in accordance with various aspects.

FIG. 8 is a flowchart of a method of generating an interactive document and providing the interactive document to a user.

FIG. 9 is a flowchart of a method of populating an account statement with targeted marketing elements.

FIG. 10 is a flowchart of a method of accessing and using an interactive financial statement.

FIG. 11 illustrates a block diagram of an example computing system operable to execute various aspects of the claimed subject matter.

FIG. 12 illustrates a schematic block diagram of an example networked computing environment in which various aspects of the claimed subject matter can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

Additionally, while the following description generally relates to generation and use of interactive financial statements, those skilled in the art will recognize that the aspects described herein can be applied to the generation of any form of interactive document that can be used for any suitable purpose. It is to be appreciated that the systems and/or methods described herein can be employed for the generation of any appropriate type of interactive document and the generation of all such documents is intended to fall within the scope of the hereto appended claims.

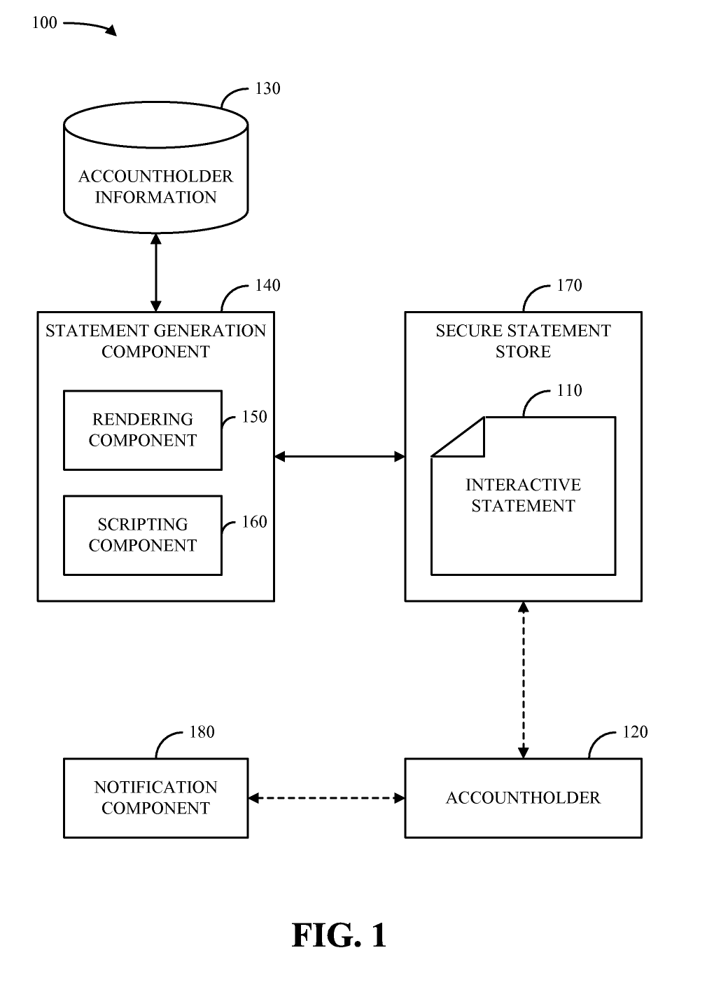

Referring now to the drawings, FIG. 1 illustrates a system 100 for generating and accessing an interactive account statement 110 in accordance with various aspects. In one example, an interactive statement 110 for an accountholder 120 can be created using information 130 relating to the accountholder 120. Accountholder information 130 that can be used can include personal information relating to the accountholder 120, information relating to one or more accounts held by an accountholder 120, and the like. Personal information can include a name, address, phone number, e-mail address, and/or other personal information of an accountholder. Account information can include account balances, account types, dates on which accounts were opened, transaction histories, and/or other suitable information.

In accordance with one aspect, accountholder information 130 can be provided to a statement generation component 140, based on which the statement generation component 140 can create an interactive online statement 110. In one example, the statement generation component 140 can be configured to generate an interactive statement 110 at regular intervals in time (e.g., weekly, monthly, quarterly, etc.). Alternatively, the statement generation component 140 can be configured to provide “on demand” generation of an interactive statement 110 or otherwise generate an interactive statement 110 in response to receiving a request from an accountholder 120. Further, the statement generation component 140 can be operable to generate an interactive statement 110 having any suitable file format. For example, an interactive statement can be generated as a Portable Document Format (PDF) file, a word processing document, a spreadsheet, a database, and/or any other suitable file format.

In another example, the statement generation component 140 can create an interactive statement 110 for multiple service areas offered by a financial or other institution that employs the statement generation component 140. For example, an interactive statement 110 can be generated for a consumer banking and/or credit account, an investment account, a corporate banking and/or credit account, accounting and/or other functions internal to the entity employing the statement generation component 140, and/or any other suitable purpose. Further, an interactive statement 110 generated by the statement generation component 140 can be a special account notification or another appropriate document apart from a traditional account statement. For example, in the event that one or more accounts of an accountholder 120 become overdrawn, the statement generation component 140 can be utilized to generate and deliver a non-sufficient funds (NSF) notice to the accountholder 120.

As illustrated in system 100, the statement generation component 140 can include a rendering component 150, which can render, format, and/or otherwise generate the visual appearance of an interactive statement 110. In one example, the rendering component 150 can populate an interactive statement 110 with accountholder information 130, advertisements and/or similar marketing elements, logos and/or other branding relating to an entity generating the interactive statement 110, and/or other suitable information using a format that can be predetermined or specified by one or more factors as will be discussed infra. Further, rendering component 150 can incorporate one or more interactive elements generated by a scripting component 160. In accordance with one aspect, the rendering component 150 and scripting component 160 can combine to generate an interactive statement 110 that is visually pleasing and easy to use, thereby improving overall accountholder satisfaction and reducing required customer support call volume associated with assisting accountholders in navigating and/or using their account statements. In accordance with another aspect, the rendering component 150 can employ one or more mechanisms to generate and format an interactive statement 110, each of which can be specific to or independent of a document format used for the interactive statement 110. Examples of such mechanisms include word processing applications, Extensible Markup Language (XML) editing applications, PDF file creation tools, image capture applications, and the like.

As further illustrated in system 100, a scripting component 160 can be employed at the statement generation component 140 to provide a rich, intuitive user experience within a document such as an interactive statement 110 generated by the statement generation component 140. In one example, the scripting component 160 can employ components of one or more mechanisms for generating rich Internet applications. Examples of such mechanisms include, but are not limited to, Java development platforms (e.g., the Java Enterprise Edition platform or Java EE), XML development platforms, multimedia authoring platforms (e.g. Adobe Flash), cross-platform web application development systems (e.g. Asynchronous JavaScript and XML or Ajax), or any other suitable mechanism or combination of mechanisms.

In accordance with one aspect, the scripting component 160 can leverage components of one or more mechanisms for generating rich Internet applications as noted above within an interactive statement 110 or other generated document to create functionality associated with rich Internet applications within the interactive statement 110. As a result, the scripting component 160 can enhance the display of and access to accountholder information 130 within an interactive statement. For example, the scripting component 160 can provide sorting, querying, and customizable display functionality for accountholder information 130 within an interactive statement 110 in addition to, or in place of, other such enhancements. By way of specific, non-limiting example, the scripting component 160 can be utilized to facilitate two-way banking operations between an accountholder 120 and a financial institution that issues an interactive statement 110. More particularly, the scripting component 160 can enable an interactive statement 110 to be used for communication from a financial institution to an accountholder 120 as well as return communication from the accountholder 120 to the financial institution. As an example, the scripting component 160 can allow an accountholder 120 to update his personal and/or account information as reflected at the financial institution through the interactive statement 110. Further, the scripting component 160 can be utilized to allow traditional banking functions, such as the transfer of funds to, from, or between accounts, to be performed within an interactive statement 110. In accordance with another aspect, the scripting component can additionally be employed to provide enhanced security for an interactive statement 110 and/or portions thereof, to incorporate targeted advertising into an interactive statement 110 based on accountholder information 130, and/or other similar uses. Each of these uses will be described in more detail infra.

Once an interactive statement 110 has been generated, it can be delivered to an accountholder 120 in a variety of ways. In one example, the interactive statement 110 can be provided to a secure statement store 170, where it can in turn be provided to an accountholder 120. The secure statement store 170 can be, for example, a secure location on the Internet or another appropriate location for storing interactive statements 110 for one or more accountholders 120. However, while a secure statement store 170 is illustrated in system 100 for storage of an interactive statement 110 for subsequent retrieval by an accountholder 120, it should be appreciated that a secure statement store 170 or other storage mechanism is not required and that interactive statements can instead be directly provided to an accountholder 120 and/or another suitable receiving entity. In one example, the secure statement store 170 can store multiple interactive statements 110 for a single accountholder 120. For example, the secure statement store 170 can store a current interactive statement 110 for an accountholder 120 as well as one or more past statements 110.

In the non-limiting example illustrated by system 100, when an interactive statement 110 has been prepared and is ready at the secure statement store 170 for an accountholder 120, the accountholder 120 can be notified that an interactive statement 110 is ready for him via a notification component 180. The notification component 180 can provide notification to an accountholder 120 in a variety of ways; for example, the notification component 180 can notify an accountholder via phone, e-mail, short message service (SMS) message, or by other appropriate means. The notification component 180 can additionally and/or alternatively be utilized to incorporate notification of an available interactive statement 110 to an accountholder 120 within transaction receipts, correspondence between the accountholder 120 and the financial institution, and/or other suitable pre-existing channels of communication between the accountholder 120 and the financial institution.

Further, the notification component 180 can, in addition to providing notification of an available statement 110 to an accountholder 120, provide instructions that can enable the accountholder 120 to access the interactive statement 110 at the secure statement store 170. These instructions can include, for example, the address of the secure location store 170 on the Internet and/or directions for accessing a interactive statement 110 relating to a particular accountholder 120 on the secure statement store 170. In response to these instructions, the accountholder 120 can then access the secure statement store 170 to retrieve his statement 110. Under certain circumstances, an accountholder 120 can be directed to retrieve other documents at the secure statement store 170 in addition to or in place of an interactive statement 110. For example, an accountholder 120 can be directed to obtain a non-sufficient funds (NSF) notice from the secure statement store 170. The NSF notice can be generated to be interactive by the statement generation component 140, and as a result the accountholder 120 can obtain the ability to transfer funds to an overdrawn account and/or otherwise mitigate the circumstances that warranted the NSF notice from within the notice itself. In another example, an accountholder 120, prior to accessing a document from the secure statement store 170, can be required to authenticate with the secure statement store prior to retrieving the document. This can be required even in the event that a notification directly links an accountholder 120 to the secure statement store 170, as the notification could be intercepted by a third party that could then utilize the notification to gain access to personal information of the accountholder 120.

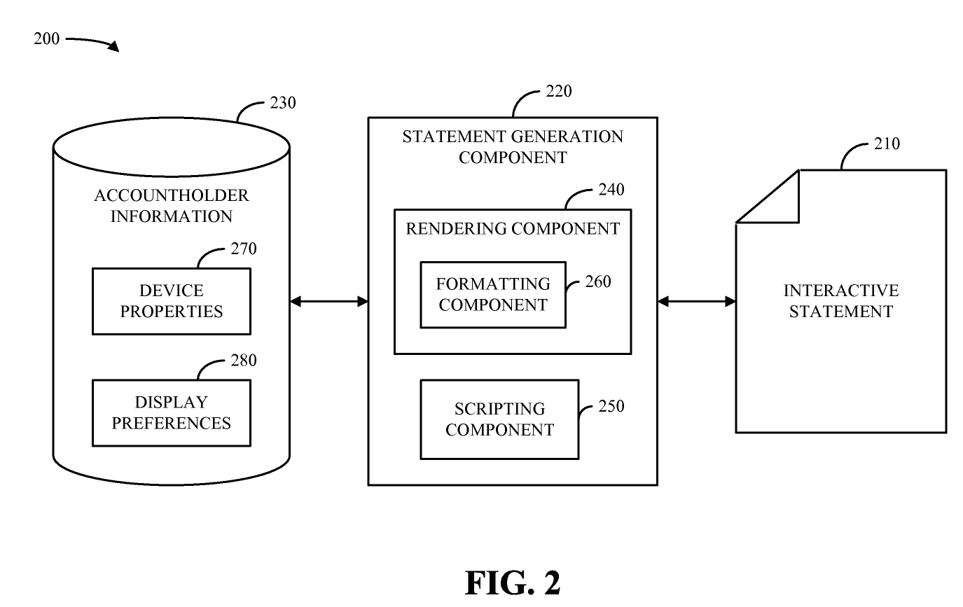

Turning now to FIG. 2, a block diagram of a system 200 for formatting and generating an interactive document, such as an interactive statement 210, is illustrated. In accordance with one aspect, system 200 includes a statement generation component 220, which can utilize accountholder information 230 to generate an interactive statement 210 or other document. It should be appreciated that while statement generation component 220 is illustrated in system 200 as generating an interactive statement 210, statement generation component 220 can be used to generate most documents for most industries or other purposes with interactive features that facilitate a rich user experience within the document(s). Further, the statement generation component 220 can include a rendering component 240 and a scripting component 250, which can function in a similar manner to that described supra with respect to system 100. Additionally, while not shown in FIG. 2, statement 210 and/or other documents produced by statement generation component 220 can be provided to a secure location (e.g., secure statement store 170) for retrieval by a user (e.g., an accountholder 120) and/or directly delivered to the user and/or another suitable entity.

In accordance with one aspect, a user can access an interactive statement 210 or other document generated by statement generation component 220 from a variety of devices, each of which may have different properties. For example, a user can access documents generated by statement generation component 220 from a desktop computer, a portable computer such as a laptop or tablet computer, a personal digital assistant (PDA), a mobile phone, and the like, which can differ in aspects such as available display area, an amount of available disk storage and/or memory at the device, and/or other properties. As a result, a single document format may not be appropriate for the generation of documents for all users. Accordingly, statement generation component 220 can employ a formatting component 220 to adaptively format an interactive statement 210 and/or other documents for a particular user that will access the documents. While the formatting component 220 is illustrated in system 200 as part of the rendering component 240, it should be appreciated that the formatting component 220 could be implemented independently of the rendering component 240 and/or the statement generation component 220.

In one example, accountholder information 230 for a user can include device properties 270 and/or display preferences 280 relating to the user. These data can then be used by the formatting component 220 to generate a format for an interactive statement 210 for the user. Device properties 270 can include the display size of a device with which a user will access an interactive statement 210, available disk storage at the device, available memory at the device, and/or other suitable properties. In addition, device properties 270 can be provided by a user and/or obtained from a user device itself. Device properties 270 can be obtained from a device via, for example, cookies and/or other information stored on and/or provided by the device that identifies the device and its properties. Display preferences 280 can include preferences of a user regarding the size, ordering, and formatting of information, which can be considered by the formatting component 220 in addition to or in place of device properties 270. For example, a list of optional features that can be utilized for an interactive statement 210 can be provided to a user, and a user can specify which of these features to utilize for the generation of his interactive statement 210 and provide these desired features as display preferences 280.

In accordance with one aspect, the formatting component 220 can utilize device properties 270 and/or display preferences 280 relating to a user to format an interactive statement 210 for the user. For example, the formatting component 220 can adjust sizes of text, tables, and/or other elements within a statement 210 and/or the statement 210 itself based on received accountholder information 230. Further, a statement 210 can be formatted to include more or fewer images depending on available memory and/or disk storage at a user device, the capacity of the user device to store and/or display images, and/or other factors.

In another example, the device properties 270 can include an indication of available document reader software at a user device. Based on this information, the statement generation component 220 can adaptively generate an interactive statement 210 using a format that is compatible with the user device. By way of non-limiting example, a statement generation component 220 can be operable to generate interactive statements 210 in a first file format and a second file format. However, a user device may only have support for the second file format. In response, the statement generation component 220 can generate a statement 210 for the user device using the second file format and/or direct the user to a document reader for the first file format. As another example, the device properties 270 can additionally identify a current version of a document reader installed on the user device. In such an example, if the statement generation component generates statements 210 using a newer version of the document reader software, the statement generation component 220 can facilitate prompting of a user to update his document reader to the version utilized by the statement generation component 220. Alternatively, the statement generation component 220 can provide a statement 210 to the user in an alternate format if the version of the document reader installed at the user device does not support features of the newer version used by the statement generation component 220 used to generate the statement 210.

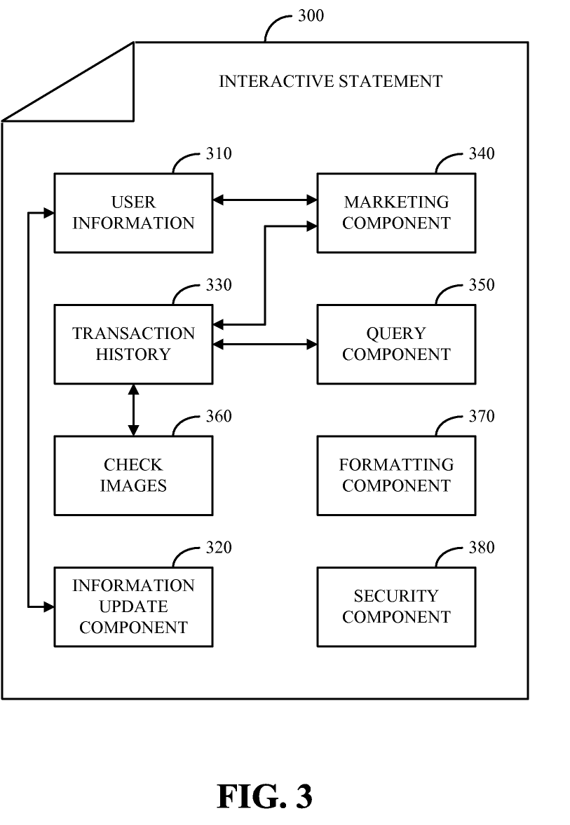

Referring to FIG. 3, an example interactive statement 300 is illustrated in accordance with various aspects described herein. More particularly, FIG. 3 illustrates various features and information that can be included in an interactive statement 300, which can be generated (e.g. by a statement generation component 140) in accordance with various aspects set forth in the subject disclosure. It should be appreciated that FIG. 3 is not intended to represent an exclusive listing of all features and information that can be implemented within an interactive statement in accordance with the subject disclosure, nor is it intended to suggest the generation of interactive statements to the exclusion of other types of suitable documents. Rather, FIG. 3 is provided to illustrate and describe various examples of features and information that can be included within a document such as an interactive statement 300 in accordance with various aspects of the claimed subject matter.

In accordance with one aspect, an interactive statement 300 can incorporate user information 310. User information 310 can include personal information regarding an accountholder for which an interactive statement 300 is generated (e.g., name, address, phone number, age, biographical information, and/or other similar information relating to an accountholder), information regarding account(s) held by the accountholder, information regarding a device used by the accountholder for accessing the interactive statement 300, preferences of the accountholder relating to display and formatting of the statement 300, and/or other appropriate information. User information 310 can include information directly provided by an accountholder and/or information obtained from a device employed by a user to obtain and/or view an interactive statement 300.

An interactive statement 300 can further include an information update component 320, which can include mechanisms by which an accountholder can update user information 310 incorporated into the interactive statement 300 from within the statement. The information update component 320 can facilitate changes to user information 310 directly within an interactive statement 300, or alternatively the information update component 320 can redirect an accountholder to a location external to the interactive statement 300 where changes to user information 310 can be made. By way of specific, non-limiting example, the information update component 320 can allow an accountholder to make changes to his personal information via a form provided in the interactive statement 300. Changes made by an accountholder using the form in the interactive statement 300 can then be provided back to the entity that generated the interactive statement 300. As another specific example, an interactive statement 300 can obtain changes and/or corrections to the personal information of an accountholder directly from information stored on a device used by the accountholder to access the interactive statement 300. Further, the information update component 320 can allow an accountholder to update information relating to one or more accounts held by the accountholder and reflected in the interactive statement 300. For example, the interactive statement 300 can enable a user to change beneficiaries on one or more accounts, manage investment and/or retirement accounts, and/or perform other similar actions. Further, the information update component 320 can also allow an accountholder to create new accounts and/or close existing accounts that are associated with the interactive statement 300.

In accordance with another aspect, an interactive statement 300 can additionally incorporate a transaction history 330 of an accountholder. In one example, the transaction history 330 can include records of transactions made by an accountholder with respect to one or more accounts held by the accountholder. In addition, the transaction history 330 can also include trends and/or other information that can be identified from records of the transactions of an accountholder. This identified information can be determined by an outside component (e.g., statement generation component 220) and used in the generation of the interactive statement 300, or alternatively the information can be identified by and utilized within the statement itself. Techniques by which trends and/or other information can be identified from transaction records are described in more detail infra.

In addition, an interactive statement 300 can provide one or more mechanisms by which an accountholder can perform account operations from within the statement, thereby modifying or adding additional transactions to his transaction history 330. For example, an interactive statement 300 can allow a transfer of funds between accounts held by a common accountholder and/or accounts held by different accountholders. Further, an interactive statement 300 can provide online bill payment functionality, wherein an accountholder can pay bills given to the accountholder by creditors, utility providers, and/or other entities. As an alternative to providing online account functionality within the statement itself, the statement can redirect an accountholder to a secure location outside the interactive statement 300 where account operations can be performed.

In accordance with another aspect, an interactive statement 300 can employ a marketing component 340. The marketing component 340 can be used, for example, to insert advertisements, surveys, and/or other marketing features into an interactive statement 300. Further, marketing features can be selected for insertion into the interactive statement 300 that are targeted to an individual accountholder based on the user information 310, transaction history 330, and/or other information relating to the accountholder. Techniques that can be used for inserting marketing features into an interactive statement 300 are discussed in more detail infra. As another example, the marketing component 340 can be utilized to incorporate a rewards redemption system into the interactive statement to allow an accountholder to redeem rewards pursuant to one or more promotional programs associated with his account(s).

An interactive statement 300 can further include a query component 350, which can allow an accountholder to perform queries and/or other operations on transactions provided in his transaction history 330 from within the statement. In accordance with one aspect, by providing transaction query functionality from within an interactive statement 300, the query component 350 can facilitate enhanced access to transaction information to accountholders as well as persons or entities that service accounts. For example, in the event that an accountholder requires assistance with a particular transaction, an interactive statement 300 containing the transaction can be provided to a customer service representative. In turn, the customer service representative can utilize the statement to find the transaction in question and assist the accountholder without being required to search through a large, generalized transaction database.

In one example, the query component 350 can provide a form or other mechanism that enables an accountholder to query and/or sort transactions reflected in the interactive statement 300. The provided form can facilitate querying and sorting of transaction data embedded into the statement itself, or alternatively querying and sorting operations can be performed on transaction data at an external location to the statement, which can then be reflected in the statement. In addition to a form, buttons or other means can be provided for quick access to common filtering, sorting, and/or other operations, as well as for disputing one or more transactions.

The interactive statement 300 can also incorporate images 360 of checks or other instruments executed by an accountholder relative to his accounts. Check images 360 can be embedded into the interactive statement 300 at the time the statement is generated, at the time the statement is accessed by an accountholder, and/or at another suitable time. Alternatively, check images 360 can be maintained at a data source external to the interactive statement 300 and provided within the statement as they are requested by an accountholder. Mechanisms by which check images 360 can be displayed in an interactive statement 300 are illustrated and described in more detail infra.

The interactive statement 300 can further include a formatting component 370, which can implement one or more mechanisms for dynamically formatting or altering the format of the statement or portions thereof to allow an accountholder to quickly and intuitively navigate and use the statement. For example, the formatting component 370 can allow an accountholder to specify a level of detail that should be used in listing information relating to transactions. Further, the formatting component 370 can incorporate logos, color schemes, and/or other branding elements of an entity that issued the interactive statement 300, thereby creating an association with the accountholder between the interactive statement 300 and an online financial institution site provided by the entity that issued the statement. As a result, the formatting component 370 can be utilized to combine the appearance and functionality of traditional online servicing with the convenience of an account statement.

In addition, the formatting component 370 can be utilized to provide various additional enhancements to the experience of an accountholder in utilizing an interactive statement 300. For example, in the event that an accountholder has questions or requires further action regarding an item on his statement, the formatting component 370 can provide means by which the accountholder can request assistance from a customer service representative. For example, the formatting component 370 can provide means to allow an accountholder to submit a message to a customer service representative or redirect the accountholder to an external customer service source. As another example, the formatting component 370 can facilitate a live chat session between an accountholder and a customer service representative from within the statement itself in the event that an accountholder requires assistance.

In another example, the formatting component 370 can detect the version of an application reader used by an accountholder to access the interactive statement 300 and determine whether the version utilized by the accountholder is sufficient to access all features of the interactive statement. If the formatting component 370 determines that the application reader software used by the accountholder is not sufficient, the formatting component can adapt the statement accordingly. For example, the formatting component 370 could disable any features not supported by the application reader, facilitate the automatic download and/or installation of sufficient application reader software, and/or take other appropriate action.

In accordance with another aspect, an interactive statement 300 can incorporate a security component 380, which can implement one or more features to provide security to the interactive statement 300 as well as individual components within the interactive statement 300. For example, the security component 380 can be employed to require a password for general access to the interactive statement 300 and/or individual features therein. In one example, features within an interactive statement can have different passwords. Thus, a first feature of the interactive statement can require a first password, a second feature can require a second password, and so on. In addition to passwords, other access control methods can be used. These include, but are not limited to, personal identification numbers (PINs), digital signature files, personal information (e.g., mother's maiden name), and the like. In one example, the security component 380 can require authentication for all access to a statement and/or a component therein, or alternatively the security component can subject an accountholder to authentication challenges at various intervals. Intervals at which an authentication challenge is performed can be, for example, based on a predetermined pattern, determined at random, based on criteria such as risk models, and/or by other means. In another example, the security component 380 can be employed to show and/or hide account numbers and/or other sensitive information within a statement. Access to hidden information within a statement can then be controlled using one or more techniques as described above.

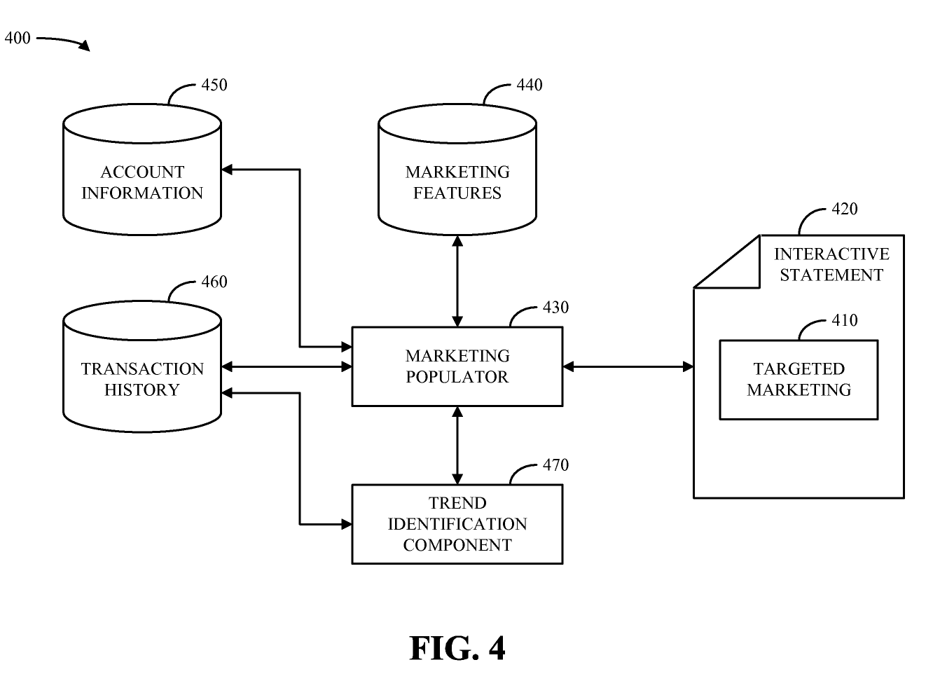

Turning to FIG. 4, a block diagram of a system 400 that facilitates inserting targeted marketing features 410 in an interactive statement 420 is illustrated. In accordance with one aspect, the targeted marketing features 410 can be inserted into an interactive statement 420 by a marketing populator 430, which can be employed as a part of or independently of a component that generates the interactive statement 420 (e.g., a statement generation component 140). It should be appreciated, however, that while system 400 illustrates the insertion of targeted marketing features 410 into an interactive statement 420, the marketing populator 430 can also be used to provide marketing features for other suitable documents.

In one example, the marketing populator 430 can receive and utilize a set of marketing features 440. Marketing features 440 can include advertisements, surveys, and/or any other suitable marketing tools. Advertisements included in the marketing features 440 can be graphical advertisements (e.g., banner advertisements), text advertisements, multimedia advertisements such as audio and/or video advertisements, and/or any other suitable type of advertisement. In the event that multiple types of advertisements are provided to the marketing populator 430, the marketing populator 430 can select a type of advertisement to be used depending on a format applied to the interactive statement (e.g., by a formatting component 260). Further, marketing features 440 can be provided by an entity that issues a corresponding interactive statement 420 (e.g., a financial institution that issues an account statement can provide advertisements for products and/or services offered by the financial institution) or by an external entity (e.g., an advertising partner of the financial institution that issues the account statement).

In accordance with one aspect, the marketing populator 430 can select marketing features 440 to include in an interactive statement 420 or other document based on account information 450 and/or the transaction history 460 of a user for which an interactive statement 420 or other document is generated. Account information 450 can include, for example, contact information of a user, accounts held by a user, account balances, and the like.

By way of specific, non-limiting example, account information 450 and/or a transaction history 460 can be utilized by the marketing populator 430 to provide marketing features 440 for an interactive statement 420 in the form of advertisements for suggested products offered by an entity that issues the interactive statement 420 based on the account information 450 and/or transaction history 460. For example, if a checking account balance for a user is low or overdrawn, marketing features 440 can be chosen to suggest an overdraft protection line or a similar product to the user. As another example, if the account information 450 of a user reflects that a user has recently executed a home loan, marketing features 440 can be chosen to suggest a home equity loan, a home equity line of credit, and/or similar products. Similarly, account information 450 that reflects that a user has a mortgage or other loan that is older than a predetermined age can be considered by the marketing populator 430 to suggest refinancing options. Further, specific transactions in the transaction history 460 of a user can be used to suggest products and/or services offered by the entity that issues the interactive statement 420 and/or outside entities. For example, if the transaction history 460 of a user reflects that the user recently purchased an automobile, marketing features 440 that advertise related products and/or services, such as auto repair centers, gas stations, and the like, can be chosen by the marketing populator 430.

In accordance with another aspect, a trend identification component 470 can be further provided within system 400 to identify trends in the transaction history 460 of a user. These trends can be provided to the marketing populator 430 to enhance the relevance of targeted marketing 410 inserted into an interactive statement 420 by the marketing populator 430. The trend identification component 470 can continuously monitor the transaction history 460 of a user, or alternatively the trend identification component 414 can receive a transaction history 460 of a user at a given point in time and identify trends in the transaction history 460 at that point in time. In one example, trends can be identified and provided to the marketing populator 430 by the trend identification component 470 at a time that the marketing populator 430 selects marketing features 440 for insertion into an interactive statement 420. This can occur, for example, at the time an interactive statement 420 is generated and/or accessed by a user.

To facilitate a greater understanding of the operation of the trend identification component 470, various examples of trends that can be identified by the trend identification component 470 and ways in which those identified trends can be utilized by the marketing populator 430 are now described. It should be appreciated, however, that the following description is provided by way of example and not limitation and that the trend identification component 470 and marketing populator 430 can operate to identify and utilize in other appropriate manners.

In one example, the trend identification component 470 can determine individual payees with which a user frequently conducts transactions. Based on these payees, the marketing populator 430 can select marketing features 440 in the form of advertisements for advertising partners of the entity that issues the interactive statement 420. It should be appreciated that advertising partners corresponding to selected marketing features can be one or more payees identified by the trend identification component 470 and/or a competing payee in the same field. For example, in the event that the trend identification component 470 determines that a user frequents a first bookstore, the marketing populator 430 can provide targeted marketing features 410 for the first bookstore or a second, competing bookstore.

In another example, the trend identification component 470 can determine types or categories of payees (e.g., grocery, sporting goods, dining, entertainment, etc.) that a user frequently conducts transactions, based on which the marketing populator 430 can select marketing features 440 relative to the determined categories. Thus, for example, if the transaction history 460 of a user reflects a large number of transactions with sporting goods stores, the marketing populator 430 can select marketing features 440 for the user related to sports and/or sporting goods.

In accordance with one aspect, the trend identification component 470 can additionally consider dates on which transactions are conducted. These data can then be utilized to identify trends of a user over time, which can enable the marketing populator 430 to provide the most relevant targeted marketing features 410 for a user at a current time. For example, if the trend identification component 470 determines that a user frequently conducts transactions for sporting goods in the summer but conducts few transactions for sporting goods in the winter, the marketing populator 430 can be configured to select more sporting-related marketing features 440 in the summer and fewer sporting-related marketing features 440 in the winter. Similarly, if the trend identification component 470 determines that a user often purchases groceries on a particular day of the week and/or time of the month, the marketing populator 430 can be configured to select more grocery-related marketing features 440 during the times at which the user is most likely to purchase groceries.

In another example, geographic locations in which a user frequently conducts transactions can also be identified by the trend identification component 470 to enable the marketing populator 430 to select marketing features 440 for businesses in those geographic locations. Often, a user may conduct frequent transactions in an area away from his home. For example, a user may make frequent visits to an area away from his home, or the user may live in a first geographic location and work in a second location. By monitoring trends relating to locations at which a user conducts transactions, the trend identification component 470 can identify these areas and allow the marketing populator 430 to provide marketing features 440 relating to these areas despite the fact that these areas may not be apparent from the account information 450 of the user alone.

It should be appreciated that the trend identification component 470, in addition to the examples listed above, could employ other suitable techniques or combinations of techniques for determining trends in a transaction history 460. Further, the trend identification component 470 can utilize one or more artificial intelligence and/or machine learning techniques. As used herein, the term “intelligence” refers to the ability to reason or draw conclusions about, e.g., infer, the current or future state of a system based on existing information about the system. Artificial intelligence can be employed to identify a specific context or action, or generate a probability distribution of specific states of a system without human intervention. Artificial intelligence relies on applying advanced mathematical algorithms—e.g., decision trees, neural networks, regression analysis, cluster analysis, genetic algorithm, and reinforced learning—to a set of available data (information) on the system. In particular, one of numerous methodologies can be used for learning from data and then drawing inferences from the models so constructed, e.g. hidden Markov models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches (that perform data fusion, etc.) in accordance with various aspects described herein.

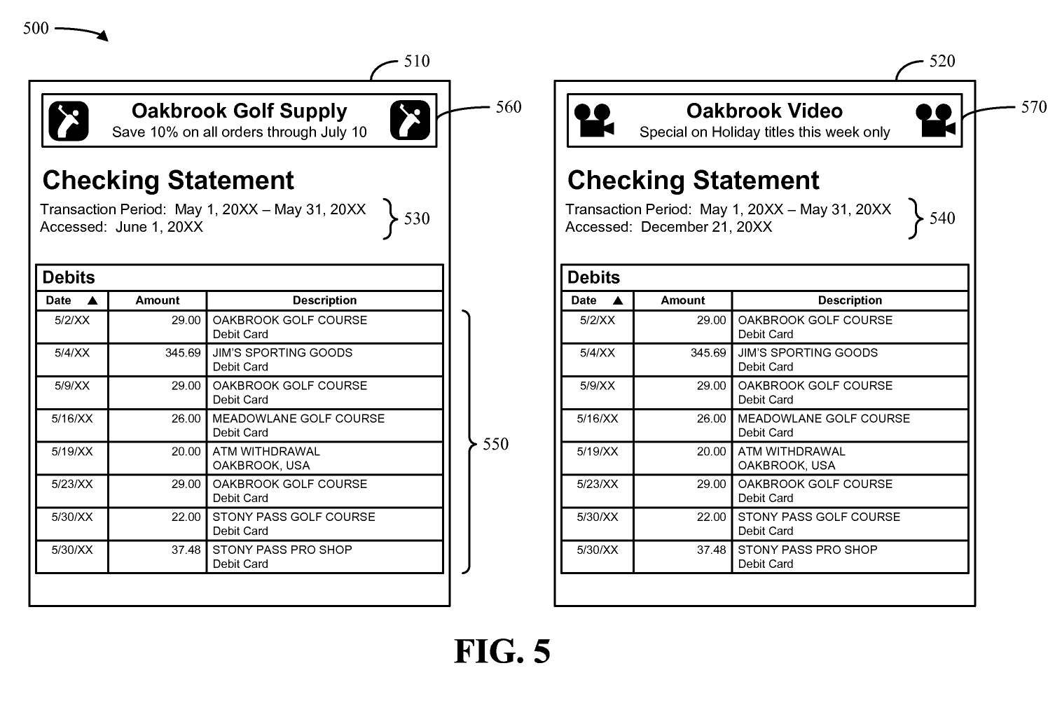

Referring now to FIGS. 5-7, various examples of interactive statements (e.g., interactive statements 30) that can be constructed in accordance with various aspects described herein are illustrated. It should be appreciated, however, that the example interactive statements illustrated by FIGS. 5-7 are provided merely as examples of ways in which an interactive statement can be generated and are not intended to imply that such illustrations are an exhaustive list of techniques by which an interactive statement can be generated or features that can be implemented in an interactive statement as described herein. Further, it should be appreciated that FIGS. 5-7 are not drawn to scale and that no scale is intended to be suggested by said figures.

Turning to FIG. 5, a diagram 500 is provided that illustrates advertisement population features of an example interactive statement in accordance with various aspects. Diagram 500 illustrates a first statement 510 and a second statement 520, which are constructed for a common transaction period as illustrated by respective information fields 530 and 540. Further, as illustrated by information fields 530 and 540, statements 510 and 520 are accessed at different times. This can indicate, for example, that statements 510 and 520 were generated (e.g. by a statement generation component 140), obtained by an accountholder (e.g., from a secure statement store 170), stored locally on a device used by the accountholder and accessed, etc., at the respective times at which they are listed as accessed.

Transaction field 550 in statement 510 illustrates a list of transactions made by an accountholder for whom statements 510 and 520 are generated during the transaction period listed in information fields 530 and 540. In one example, transactions listed in transaction field 550 reflect all or part of a transaction history (e.g., a transaction history 330) of the accountholder. As can be observed within transaction field 550, the accountholder for which statements 510 and 520 were generated conducted many golf-related transactions during the listed transaction period. Further, it can be observed that many transactions conducted by the accountholder originate from a location named Oakbrook.

Based on these transactions, trends can be identified (e.g., by a trend identification component 470) that indicate that the accountholder frequently conducts golf-related transactions and that the accountholder conducts many transactions in Oakbrook. As a result, an advertisement 560 relative to these trends can be selected and placed into the statement 510. As illustrated in statement 510, advertisement 560 relates to an entity in the business of selling golf equipment in Oakbrook, thereby reflecting both a category of payees (e.g. golf-related payees) and a location (e.g., Oakbrook) to which the accountholder frequently conducts transactions.

Further, it can be observed that the advertisement 560 illustrates particular dates, namely a sale on golf supplies that expires on July 10, 20XX. Thus, in accordance with one aspect, an advertisement 560 inserted into a statement 510 can change over time. This is illustrated in statement 520, which illustrates a statement directed to the same accountholder and transaction period as statement 510 but accessed at a different point in time. In one example, while an accountholder may conduct many golf-related transactions in the spring and summer months, the accountholder may not conduct as many golf-related transactions in the winter months such as December, when statement 520 is accessed according to information field 540. Accordingly, an advertisement 570 for a different type of business can be provided in statement 520 during these time periods. As illustrated in statement 520, an advertisement 570 for a video store in Oakbrook is provided in place of the golf-related advertisement 560 in statement 510. This suggests that the accountholder may still conduct frequent transactions in Oakbrook during the winter months despite not conducting as many golf-related transactions. In addition, it can be observed that advertisement 570 is related to a holiday sale, which illustrates that advertisements can be specifically provided to be relevant for a date at which a statement is accessed.

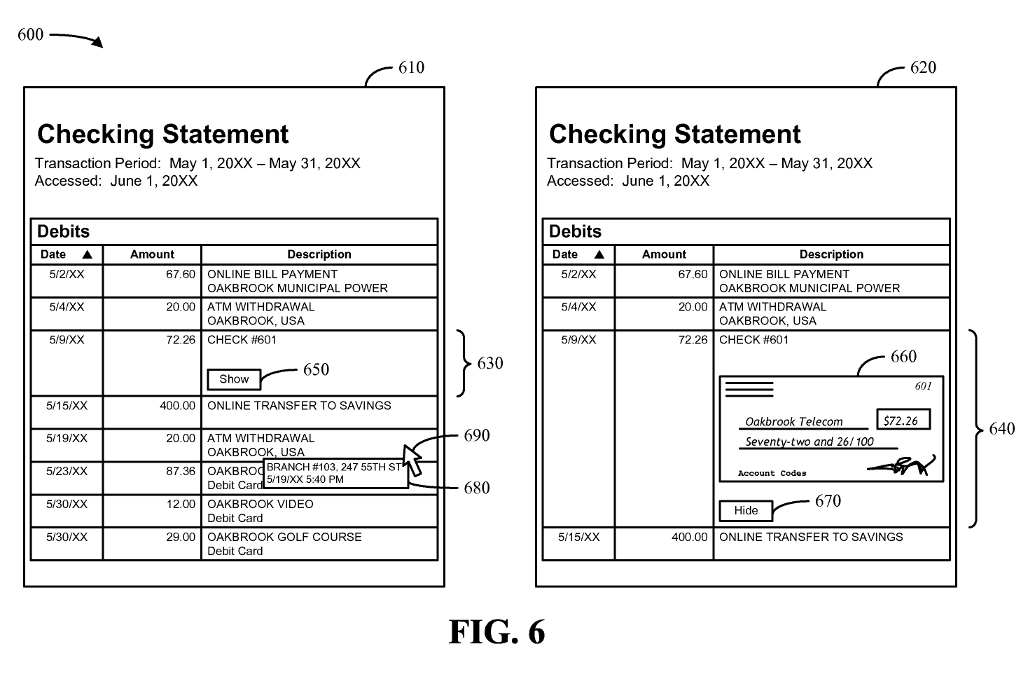

Referring now to FIG. 6, a diagram 600 is provided that illustrates display features of an example interactive statement in accordance with various aspects. Diagram 600 illustrates a first statement 610 and a second statement 620, which are constructed using a common set of transactions over a common time period. As illustrated by statements 610 and 620, each transaction for which a statement is generated can have a record in an appropriate section of the statement. While statements 610 and 620 illustrate only a section for debit transactions, it should be appreciated that any number of sections can be provided, which can correspond to any suitable grouping of transactions. Alternatively, all transactions can occupy a single section. Further, transactions in statements 610 and 620 can be grouped as a list where each transaction corresponds to an entry, such as entries 630 and 640. Entries can be divided into sections for different types of information regarding the transaction. For example, as illustrated in statements 610 and 620, sections are provided for the date, amount, and description of various transactions. In one example, entries in a statement can be sorted by various criteria by, for example, clicking or otherwise engaging a section heading or by any other appropriate means.

In accordance with one aspect, information displayed in the description of a transaction can vary depending on a category of transaction. For example, depending on the category of transaction, a transaction type, payee, location, check number, and/or other information can be listed. As further illustrated by statement 610, a button 650 or a similar control region can be displayed in an entry 630 corresponding to a transaction involving a check or other written instrument. When the button 630 is engaged by the user, the display of the statement can change as illustrated by statement 620, where an image 660 of the written instrument can be provided in the entry 640 for the transaction. When a check image 660 or other written instrument is displayed, a second button 670 and/or other control region can be displayed to enable the user to hide the image 660 and return the statement to its original state as illustrated by statement 610.

While diagram 600 illustrates a check image 660 displayed within a statement 620, it should be appreciated that the check image 660 could also be provided to an external image viewer or otherwise provided to a user as a file that is separate from the statement 620. Additionally, check images 660 can be provided for display within statement 620 based on various techniques. For example, check images 660 can be embedded into a statement 620 at the time the statement is generated. Alternatively, a statement 620 can be configured to receive check images 660 from a location on the Internet or another suitable source at the time the statement is opened or otherwise accessed. As an additional alternative, check images 660 within a statement 620 can be individually obtained from an external source as they are requested by a user. The latter technique can be used, for example, for a statement generated for a device with a small amount of available disk storage and memory to reduce system resources required for the statement.

In another example, transaction information can be further configured to display additional information upon a request by a user. As illustrated in statement 610, this information can be provided in a tooltip 680, which can be displayed when a user positions a cursor 690 over a transaction. As illustrated in statement 610, information such as an address, date, and time at which a transaction was conducted and/or other suitable information can be displayed in a tooltip 690.

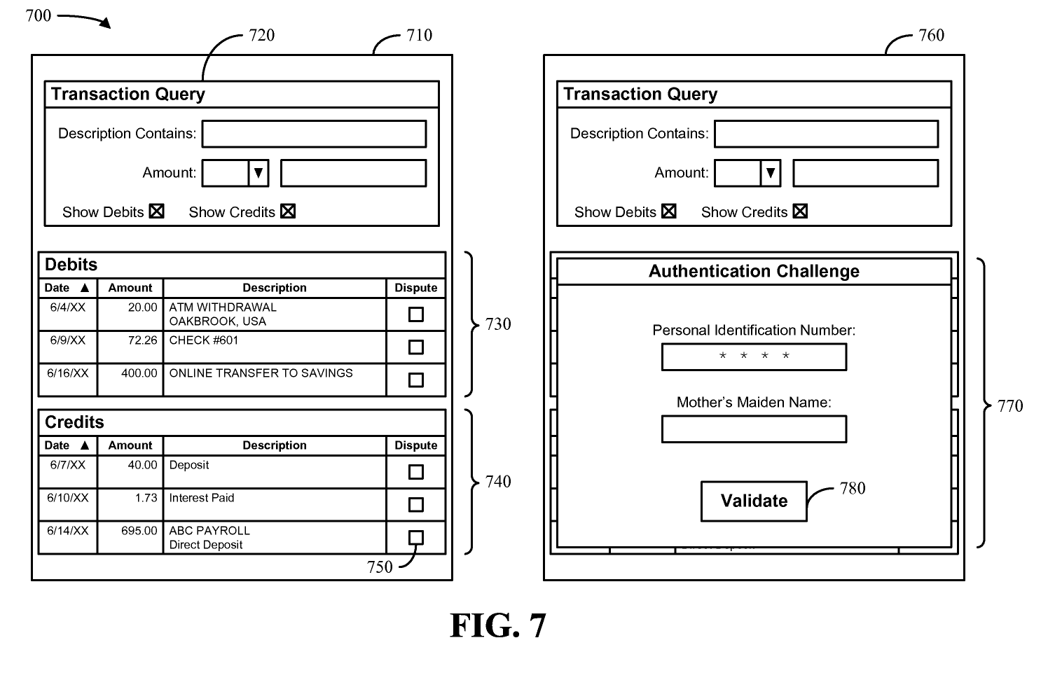

Turning to FIG. 7, a diagram 700 is provided that illustrates query and authentication features of an example interactive statement in accordance with various aspects. In accordance with one aspect, query and dispute features that can be provided for a set of transactions in an interactive statement are illustrated in a first statement 710. As illustrated in statement 710, a query dialog box 720 can be provided within a statement 710 to facilitate enhanced searching and navigation through transactions reflected in the statement 710. As query dialog box 720 illustrates, queries on transactions within a statement 710 can be performed according to multiple criteria, such as words or phrases in their respective descriptions, transaction amount, transaction type, and the like. It should be appreciated that the query fields provided in query dialog box 720 are provided as non-limiting examples and that other query fields could additionally and/or alternatively be provided.

Upon entering a query into query dialog box 720, results of the query can be displayed in transaction fields 730 and/or 740. As illustrated by statement 700, separate result fields 730 and 740 can be provided according to transaction groupings specified in the query. Alternatively, result fields can be provided to any other appropriate grouping, or a single result field could be provided. As additionally illustrated in statement 710, a dispute checkbox 750 and/or other control region can be provided for each transaction in the result fields 730 and/or 740. Upon engaging a dispute checkbox 750, a user can be redirected to a customer support specialist for an entity that issued the statement or otherwise directed to seek assistance regarding his dispute.

As further illustrated by statement 760, access to various portions of a statement, such as query functionality or the ability to view query results, can be locked using an authentication challenge dialog box 770. An authentication dialog box 770 can be imposed into a statement 760 upon each attempted access to a predetermined feature within the statement, or alternatively authentication challenges can be made according to a random or predetermined pattern or based on criteria such as risk models. As illustrated by the authentication challenge dialog box 770, a user can be required to validate various authentication data before he is able to utilize the requested functionality within the statement 760. While dialog box 770 illustrates specific examples of a personal identification number and the maiden name of the user's mother, it should be appreciated that other authentication data and/or combinations thereof could be used. Upon entering the requested information, the user can submit the information by engaging a validation button 780. The statement 760, or an external authentication entity, can then validate the information provided by the user against information previously provided by the user (e.g., during account registration or another previous event). Access can then be granted to the challenged features upon successful validation and/or denied upon unsuccessful validation.

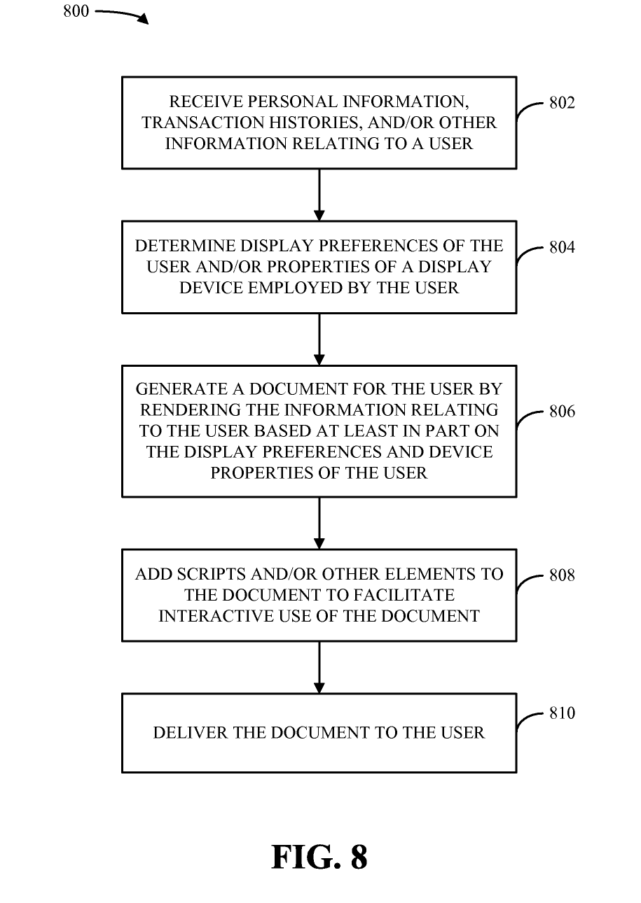

Referring now to FIGS. 8-10, methodologies that can be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks can, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter can be described in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired in various embodiments. Furthermore, as will be appreciated, various portions of the disclosed systems above and methods below can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 8, a flowchart 800 of a method of generating an interactive document (e.g., an interactive statement 210) and providing the interactive document to a user (e.g., an accountholder 120) is illustrated. At 802, personal information, transaction histories, and/or other information relating to a user (e.g., accountholder information 230) are received. At 804, display preferences of the user (e.g., display preferences 280) and/or properties of a display device employed by the user (e.g., device properties 270) are determined. At 806, a document is generated for the user (e.g., by a rendering component 240 and/or a formatting component 260 at a statement generation component 220) by rendering the information relating to the user received at 802 based at least in part on the display preferences and device properties of the user determined at 804. At 808, scripts and/or other elements are added to the document generated at 806 (e.g., by a scripting component 250) to facilitate interactive use of the document. At 810, the document is delivered to the user (e.g. provided to a secure statement store 170 for retrieval by the user and/or delivered directly to the user).

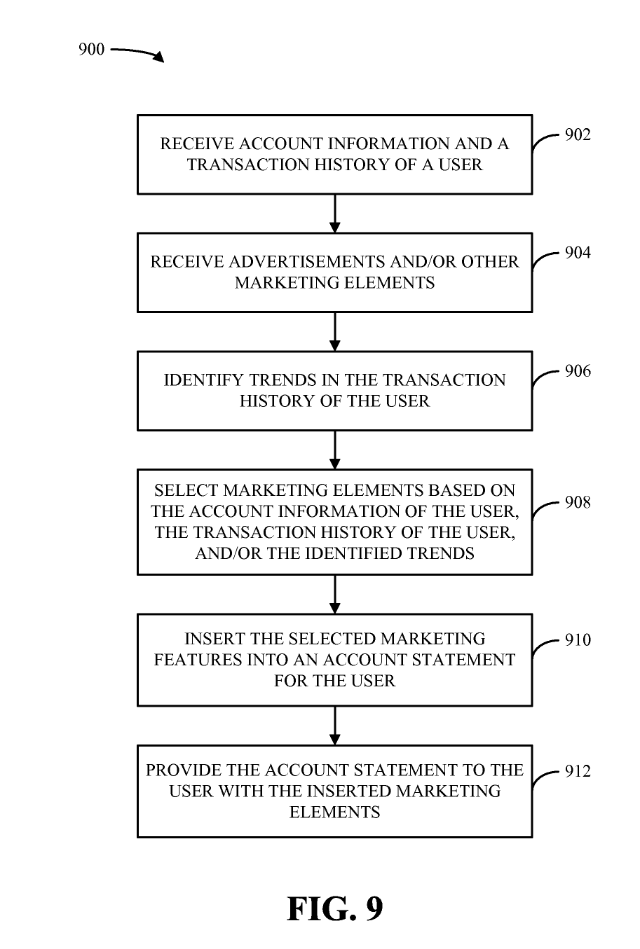

FIG. 9 is a flowchart 900 of a method of populating an account statement (e.g. an interactive statement 420) with targeted marketing elements (e.g. targeted marketing 410). At 902, account information (e.g., account information 450) and a transaction history (e.g., a transaction history 460) of a user is received. At 904, advertisements and/or other marketing elements (e.g. marketing features 440) are received. At 906, trends in the transaction history of the user received at 902 are identified (e.g., by a trend identification component 470). At 908, marketing elements are selected (e.g., by a marketing populator 430) based on the account information and transaction history of the user received at 902 and/or the trends identified at 906. At 910, the selected marketing features are inserted into an account statement for the user. At 912, the account statement is provided to the user with the inserted marketing elements.

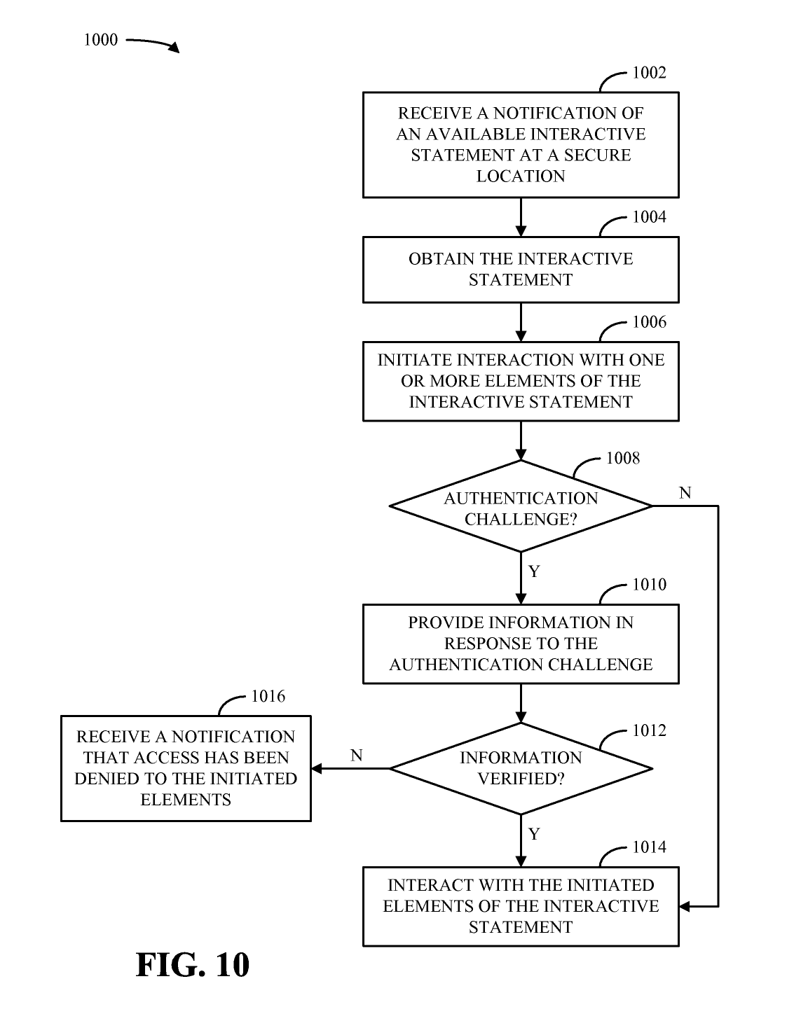

FIG. 10 is a flowchart 1000 of a method of accessing and using an interactive financial statement (e.g. an interactive statement 110). At 1002, a notification of an available interactive statement at a secure location (e.g., a secure statement store 170) is received (e.g. from a notification component 180). At 1004, the interactive statement is obtained (e.g., from the secure statement store 170 and/or from a statement generation component 140). At 1006, interaction with one or more elements of the interactive statement is initiated. At 1008, it is determined whether an authentication challenge has been issued (e.g. by a security component 380). If no challenge is issued, method 1000 proceeds to 1014, where interaction with the elements of the interactive statement initiated at 1006 is conducted. On the other hand, if an authentication challenge is issued at 1008, method 1000 instead proceeds to 1010, where information is provided in response to the authentication challenge. At 1012, it is determined whether the information provided at 1010 is successfully verified. If the information is not successfully verified, authentication fails and method 1000 proceeds to 1016, where a notification is received that access has been denied to the elements with which interaction was initiated at 1006. If authentication instead succeeds at 1012, method 1000 can continue to 1014, wherein interaction with the elements with which interaction was initiated at 1006 is allowed to proceed.

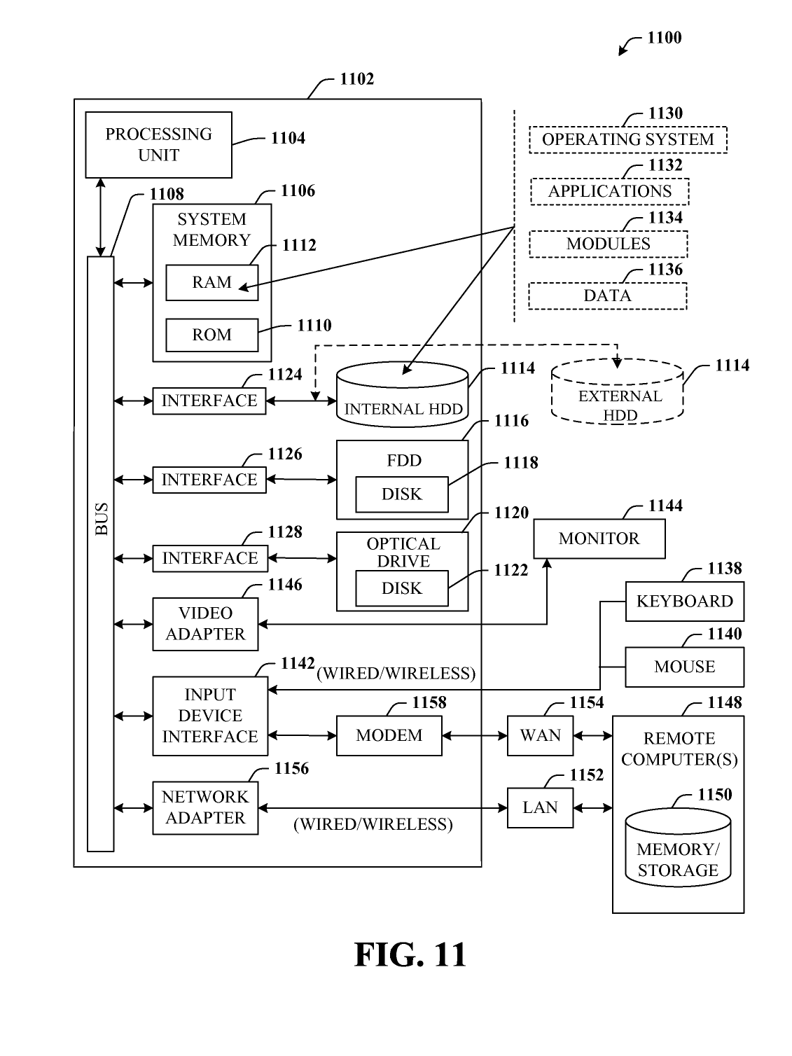

In order to provide additional context for various aspects described herein, FIG. 11 and the following discussion are intended to provide a brief, general description of a suitable computing environment 1100 in which various aspects of the claimed subject matter can be implemented. Additionally, while the above features have been described above in the general context of computer-executable instructions that may run on one or more computers, those skilled in the art will recognize that said features can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, an exemplary environment 1100 for implementing various aspects described herein includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the claimed subject matter can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, a serial port, an IEEE-1394 port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 11156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10BaseT wired Ethernet network.

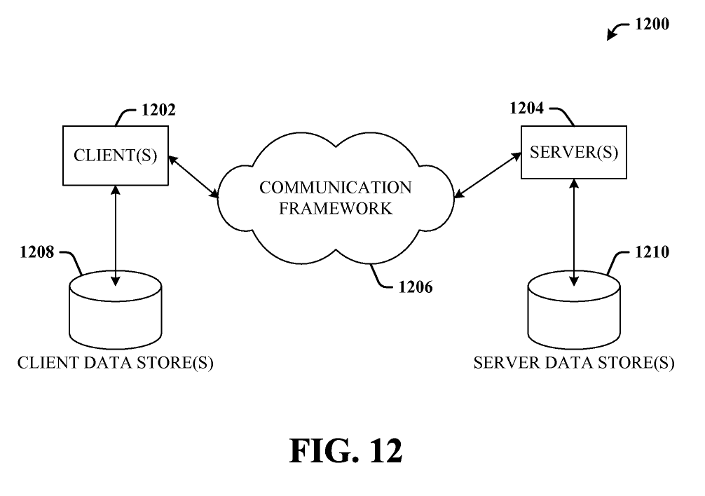

Referring now to FIG. 12, there is illustrated a schematic block diagram of an example networked computing system 1200 in which various aspects of the claimed subject matter can function. The system 1200 can include one or more client(s) 1202, which can be hardware and/or software (e.g., threads, processes, computing devices). In one example, the client(s) 1202 can house cookie(s) and/or associated contextual information by employing one or more features described herein.

The system 1200 can also includes one or more server(s) 1204, which can also be hardware and/or software (e.g., threads, processes, computing devices). In one example, the servers 1204 can house threads to perform transformations by employing one or more features described herein. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A method of generating an interactive account statement, comprising:
receiving information relating to an accountholder;
identifying properties of a device employed by the accountholder for viewing documents;
rendering the information relating to the accountholder into an interactive account statement for the accountholder based at least in part on the identified properties of the device employed by the accountholder;
incorporating one or more interactive features into the interactive account statement, the interactive features facilitate two-way interaction between the accountholder and an entity that generates the interactive statement; and
delivering the interactive account statement to the accountholder.

2. The method of claim 1, wherein the identified properties of a device employed by the accountholder for viewing documents comprise one or more of a display size of the device, available memory at the device, and available disk storage at the device.

3. The method of claim 1, wherein the incorporating one or more interactive features into the interactive account statement comprises:
selecting one or more marketing elements based on the information relating to the accountholder; and
populating the interactive account statement with the one or more selected marketing elements.

4. The method of claim 3, wherein the information relating to the accountholder comprises information relating to one or more accounts held by the accountholder and the selecting one or more marketing elements comprises selecting one or more marketing elements that suggest account servicing features based on the information relating to the one or more accounts held by the accountholder.

5. The method of claim 3, wherein the information relating to the accountholder comprises a transaction history of the accountholder and the selecting one or more marketing elements comprises:
identifying trends with respect to the transaction history of the accountholder; and
selecting one or more marketing elements based at least in part on the identified trends.

6. The method of claim 5, wherein the identifying trends with respect to the transaction history of the accountholder comprises identifying varying patterns in the transaction history of the accountholder over time and the selecting one or more marketing elements comprises selecting one or more marketing elements based at least in part on the varying patterns in the transaction history of the accountholder identified over time in relation to a time at which the marketing elements are selected.

7. The method of claim 3, wherein the populating the interactive account statement with the one or more selected marketing elements comprises populating the interactive account statement with the one or more selected marketing elements at a time the interactive account statement is retrieved by the accountholder.

8. The method of claim 1, wherein the interactive account statement is rendered as a Portable Document Format (PDF) file.

9. The method of claim 1, wherein the delivering the interactive account statement to the accountholder comprises providing the interactive account statement to a secure location for subsequent retrieval by the accountholder.

10. A system that facilitates generating an interactive statement, comprising:
a formatting component that determines a format to be utilized for the generation of a statement for a user based at least in part on properties relating to a display device employed by the user;
a rendering component that obtains information relating to the user and creates a statement for the user based on the obtained information and the format determined by the formatting component; and
a scripting component that incorporates one or more interactive elements into the statement created by the rendering component to facilitate rich Internet application functionality from within the created statement.

11. The system of claim 10, wherein the formatting component additionally determines a format to be utilized for the generation of a statement for the user based on preferences of the user.

12. The system of claim 10, further comprising a marketing populator that selects one or more marketing features based at least in part on the information relating to the user obtained by the rendering component and populates the statement created by the rendering component with the selected marketing features.

13. The system of claim 12, further comprising a trend identification component that determines one or more trends relating to the information relating to the user obtained by the rendering component, wherein the marketing populator selects marketing features based at least in part on the one or more determined trends.

14. The system of claim 10, wherein the scripting component facilitates imposition of authentication challenges that control access to one or more of the interactive elements of the statement.

15. The system of claim 10, wherein the information relating the user comprises one or more images of written instrument(s) executed by the user and the scripting component facilitates selective display of the images.

16. A method of retrieving and utilizing an interactive document, comprising:
providing one or more properties relating to a device to be used for accessing a document to an entity that creates the document;
receiving the document, the document is generated based on the provided properties and comprises one or more interactive features that facilitate rich Internet application functionality from within the document; and
interacting with the one or more interactive features in the document.

17. The method of claim 16, wherein the receiving the document comprises:
receiving a notification from the entity that creates the document that the document has been generated and is available at a secure location; and
obtaining the document from the secure location.

18. The method of claim 16, wherein the interacting with the one or more interactive features in the document comprises:
initiating interaction with the one or more interactive features;
receiving an authentication challenge within the document in response to initiating interaction with the one or more interactive features;
providing authentication information in response to the authentication challenge; and
upon successful verification of the authentication information, interacting with the one or more interactive features.

19. The method of claim 16, wherein the interacting with the one or more interactive features in the document comprises adjusting a level of detail used for information listed in the document.

20. The method of claim 19, wherein the interacting with the one or more interactive features in the document further comprises positioning a cursor over a portion of the information listed in the document to display a tooltip containing more detail relating to the portion of the information over which the cursor is positioned.

21. The method of claim 16, wherein the interacting with the one or more interactive features in the document comprises submitting a request for assistance relating to the document from within the document.

22. The method of claim 16, wherein the interacting with the one or more interactive features in the document comprises performing a query on information listed in the document, wherein information responsive to the query is listed within the document upon performing the query.

23. The method of claim 16, wherein the interacting with the one or more interactive features in the document comprises interacting with an advertisement placed within the document, the advertisement is dynamically targeted to the document based on information listed in the document.

24. A system for receiving and using an interactive financial statement, comprising:
means for relaying properties relating to a display device to an entity responsible for generating an interactive financial statement;
means for receiving a notification that an interactive financial statement has been prepared based on the relayed properties and is available at a secure location;
means for retrieving the interactive financial statement from the secure location; and
means for interacting with one or more interactive elements of the interactive financial statement.

25. The system of claim 24, wherein the properties relating to the display device comprise at least one of a display size of the display device, available memory at the display device, or available disk storage space at the display device.
